(19) United States
(12) Patent Application Publication
(10) Pub. No.: US 2010/0257556 A1
(43) Pub. Date: Oct. 7, 2010

(54) APPARATUS AND METHOD FOR PROVIDING LOCATION BASED BROADCAST SERVICE

(75) Inventors: Bong Ho Lee, Daejeon (KR); Hyun Lee, Daejeon (KR); Namho Hur, Daejeon (KR); Soo In Lee, Daejeon (KR); Jin Woong Kim, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/746,740

(22) PCT Filed: Aug. 25, 2008
(86) PCT No.: PCT/KR08/04971

§ 371 Date: Jun. 7, 2010

(30) Foreign Application Priority Data
Dec. 6, 2007 (KR) 10-2007-0126209

(51) Int. Cl. H04N 5/445

(52) U.S. Cl. 725/39

(57) ABSTRACT

Disclosed are an apparatus and method for providing a location based broadcasting service. The apparatus includes a broadcasting network receiving module to receive a broadcasting signal transmitted via a broadcasting network, a communications network receiving module to receive a data signal transmitted via a communications network, and a location based service module to provide, to a user, program information according to location information of the user using service information received from either the broadcasting network receiving module or a communications network receiving module, the service information being included in either the broadcasting signal or the data signal.

### TECHNICAL FIELD

The present invention relates to an apparatus and method for providing a location based broadcasting service, and more particularly, to an apparatus and method for providing a location based broadcasting service which may interconnect programs and data provided in a digital broadcasting system with location information, and provide the interconnected information.

This work was supported by the IT R&D program of MIC/IITA. [2007-S-004-1, Development of Glassless Single-User 3D Broadcasting Technologies]

### BACKGROUND ART

A conventional method for providing program information in a digital broadcasting system may provide program information composing the corresponding services using Service Information (SI). The conventional method for providing the program information may provide services provided in the corresponding broadcasting network or other broadcasting network using various service information tables. In the case of a Digital Video Broadcasting (DVB) system, the service information may be provided to a user terminal via a broadcasting network using a Digital Storage Media Command and Control (DSM-CC) section table such as the NIT, SDT, and EIT based on a Program Association Table (PAT) and a Program Map Table (PMT) provided in a Moving Picture Expert Group (MPEG)-2 system.

Also, an Advanced Television System Committee (ATSC) system may provide the service information to the user terminal in a similar method as the DVB system using a Program and System Information Protocol (PSIP) table whose name and function are similar with that of the DSM-CC section table, and whose entire function is identical to that of the DSM-CC section table. Also, in the case of a Terrestrial Digital Multimedia Broadcasting (T-DMB) for providing mobile multimedia broadcasting services, the service information may be provided to the user terminal using Multiplex Configuration Information (MCI)/ Service Information (SI).

The above-described conventional fixed or mobile digital broadcasting system may provide only the service information commonly provided within a specific broadcasting network covered by the corresponding frequency. The above-described service providing method may be required to define and provide separate information when providing service information restricted in a specific region or small scale region within an area covered by the corresponding frequency.

In this regard, the conventional service providing method may disadvantageously have restrictions in providing program information associated with the specific region. Accordingly, in order to overcome the restrictions, definition for either a separate detailed field or a new table having a similar type as the existing table may be needed.

### DISCLOSURE OF INVENTION

### Technical Problem

An aspect of the present invention provides an apparatus and method for providing a location based broadcasting service which may classify and generate service information related with location information of a user terminal, thereby providing optimizing program information or broadcasting event information according to a mobile environment of the user terminal.

An aspect of the present invention provides an apparatus and method for providing a location based broadcasting service which may automatically or manually provide program information related with location information of a user terminal using a Global Positioning System (GPS) receiving module.

An aspect of the present invention provides an apparatus and method for providing a location based broadcasting service which may provide, to a user terminal, essential program information, event information, and location information related with any specific location, or location related effective information.

### Technical Solution

According to an aspect of the present invention, there is provided an apparatus for providing a location based-broadcasting service, the apparatus including: a broadcasting network receiving module to receive a broadcasting signal transmitted via a broadcasting network; a communications network receiving module to receive a data signal transmitted via a communications network; and a location based service module to provide, to a user, program information according to location information of the user using service information received from either the broadcasting network receiving module or a communications network receiving module, the service information being included in either the broadcasting signal or the data signal.

In this instance, the service information may include at least one of the location information and the program information. Also, the location based service module may include a location information database to interconnect the location information and the program information and maintain the interconnected information, the location information and the program information each being detected using the service information received from either the broadcasting network receiving module or the communications network receiving module; and a service providing module to extract, from the location information database, program information associated with location information required by the user, and provide the extracted program information to the user.

According to an aspect of the present invention, there is provided an apparatus for providing a location based broadcasting service, the apparatus including: a broadcasting network receiving module to receive a broadcasting signal transmitted via a broadcasting network; a communications network receiving module to receive a data signal transmitted via a communications network; a Global Positioning System (GPS) receiving module to determine location information of a user; and a location based service module to provide, to the user, program information according to the location information of the user received from the GPS receiving module using service information received from either the broadcasting network receiving module or the communications network receiving module, the service information being included in either the broadcasting signal or the data signal.

In this instance, the service information may include at least one of the location information and the program information, and the location based service module may includes: a location information database to interconnect the location information and the program information and maintain the interconnected information, the location information and the program information each being detected using the service information received from either the broadcasting network receiving module or the communications network receiving module; and a service providing module to extract, from the location information database, program information associated with location information received from the GPS receiving module, and provide the extracted program information to the user.

According to an aspect of the present invention, there is provided a method for providing a location based broadcasting service, the method including: classifying a broadcasting coverage into at least one specific region; generating service information including location information of the specific region and program information associated with the location information; and providing the service information to a user terminal using either a broadcasting network or a communications network.

### BRIEF DESCRIPTION OF THE DRAWINGS

FIG. 1 is a schematic diagram illustrating an apparatus and method for providing a location based broadcasting service according to an exemplary embodiment of the invention;

FIG. 2 illustrates an example for classifying a specific region within a general broadcasting coverage;

FIG. 3 is a block diagram illustrating an apparatus for providing a location based broadcasting service according to an exemplary embodiment of the present invention;

FIG. 4 is a block diagram illustrating another apparatus for providing a location based broadcasting service according to an exemplary embodiment of the present invention; and

FIG. 5 is an operation flowchart illustrating a method for providing a location based broadcasting service according to an exemplary embodiment of the invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

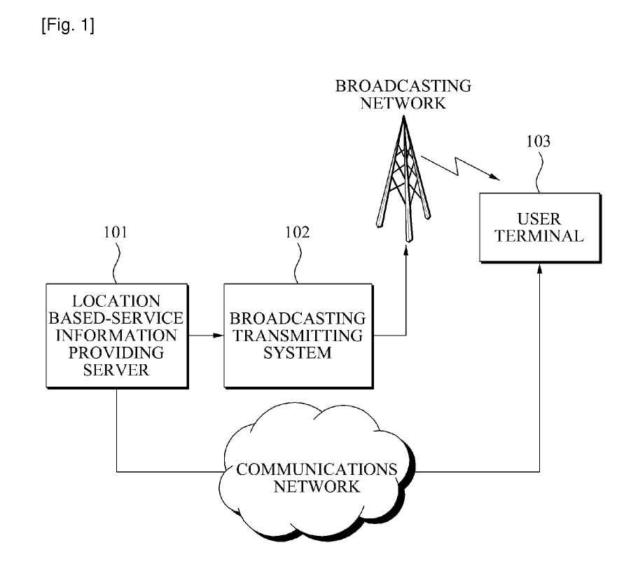

FIG. 1 is a schematic diagram illustrating an apparatus and method for providing a location based broadcasting service according to an exemplary embodiment of the invention.

As illustrated in FIG. 1, a location based service information providing server 101 may generate service information associated with location information of a user terminal 103. In this instance, the location based service information providing server 101 may transmit the generated service information to the user terminal 103 via a broadcasting network. Also, according to the present exemplary embodiment of the invention, the location based service information providing server 101 may transmit the service information to a broadcasting transmitting system 102, and the broadcasting transmitting system 102 may enable the service information to be included in a broadcasting signal intended to be provided to the user terminal 103, and transmit the broadcasting signal to the user terminal 103.

Also, according to the present exemplary embodiment of the invention, the location based service information providing server 101 may transmit the service information to the user terminal 103 via a communications network. In this instance, the service information may be provided to the user terminal 103 in a data signal type.

The service information may include location information and program information in such a manner that the location information and the program information are matched with each other. In addition, the program information may be predetermined information or a predetermined event each related with a broadcast provided to the user terminal.

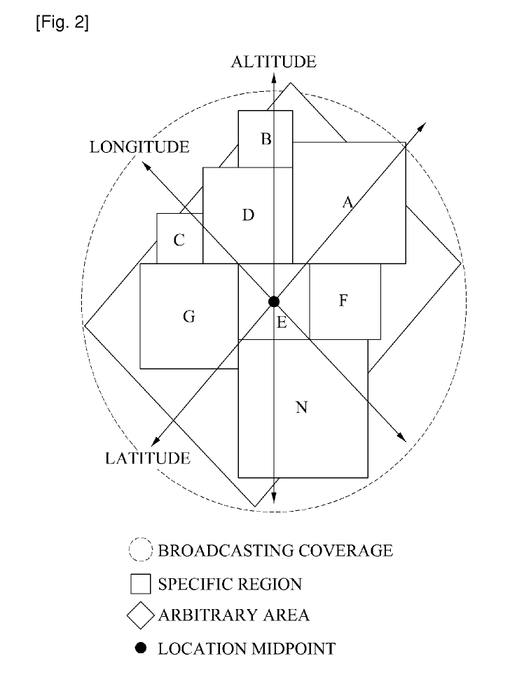

Also, the user terminal 103 may receive program information depending on the location information. In this instance, a specific region where the user terminal 103 is located may be classified according to a predetermined criterion within a broadcasting coverage. Descriptions for classifying the specific region will be herein described in detail with reference to FIG. 2.

FIG. 2 illustrates an example for classifying a specific region within a general broadcasting coverage.

As described above, the user terminal may receive the service information depending on the location information. In this instance, the location information may be defined as a longitude, latitude, and altitude. The location information may be determined by a Global Positioning System (GPS) receiving module for determining a location of a user, particularly, a terminal in real time.

As illustrated in FIG. 2, the location information may be determined for each specific region enabled to be classified within a broadcasting coverage covered by a predetermined transmitting station. The specific region may be used to provide location based information to the user by separately composing a program corresponding to the specific region within the broadcasting coverage when the user is located within the corresponding region or wishes to obtain program information corresponding to a user's location, the related contents, or desired information. For example, when a user terminal is located in a ‘E’ region within the broadcasting coverage, program information related with the ‘E’ region may be provided.

Also, as illustrated in FIG. 2, the location information may be expressed as a longitude, a latitude, and an altitude with respect to a location midpoint within the broadcasting coverage, and each of the specific regions may have a coverage such as a longitude radius, a latitude radius, and an altitude radius with respect to the location midpoint.

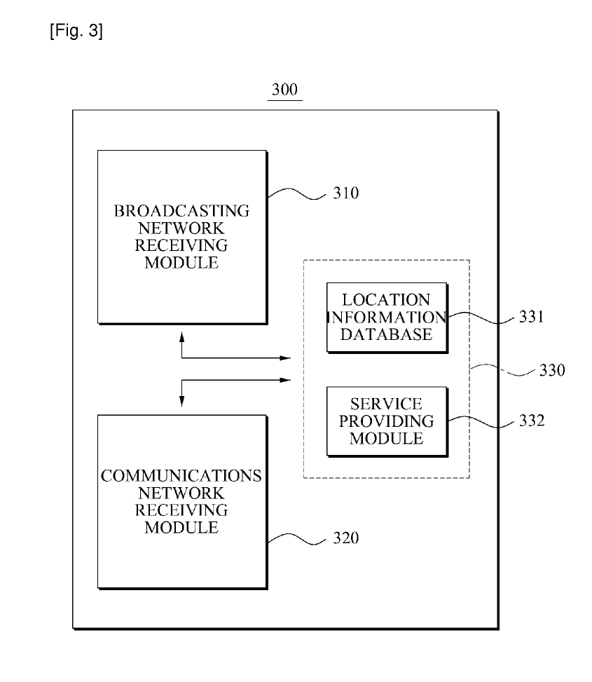

FIG. 3 is a block diagram illustrating an apparatus 300 for providing a location based-broadcasting service according to an exemplary embodiment of the present invention.

As illustrated in FIG. 3, the apparatus 300 for providing the location based-broadcasting service may include a broadcasting network receiving module 310, a communications network receiving module 320, and a location based service module 330.

The broadcasting network receiving module 310 may receive a broadcasting signal transmitted via a broadcasting network. Also, the broadcasting network receiving module 310 may receive the broadcasting signal transmitted via digital or analog broadcasting networks, and process the broadcasting signal.

Also, the broadcasting network receiving module 310 may receive service information included in the broadcasting signal via the broadcasting network from a location based service information providing server. Also, the broadcasting network receiving module 310 may receive, from the location based-service information providing server via a broadcasting transmitting system managing the broadcasting signal, the service information included in the broadcasting signal.

In this instance, the broadcasting transmitting system may include various kinds of broadcasting system such as general Digital Television (DTV) broadcasting systems (Digital Video Broadcasting (DVB) system, Advanced Television System Committee (ATSC) system, and the like), a Terrestrial Digital Multimedia Broadcasting (T-DMB) for providing mobile multimedia broadcasting services, a Satellite Digital Multimedia Broadcasting (S-DMB), and a Digital Video Broadcasting-Handheld (DVB-H). Also, the broadcasting transmitting system may denote an entire system for transmitting broadcasting signals while satisfying the corresponding standard. According to the present exemplary embodiment of the invention, in the case of the DMB, the broadcasting transmitting system may include a media coding device, a multiplexer, a modulator, and a transmitter.

The communications network receiving module 320 may receive a data signal transmitted via a communications network. Also, the communications network receiving module 320 may receive a data signal provided via the communications network, and process the data signal.

Also, the communications network receiving module 320 may receive, from the location based-service information providing server via the communications network, the service information included in the data signal.

Specifically, the location based service information providing server may classify the broadcasting coverage into specific regions, and compose location information about the corresponding region and program information associated with the corresponding location, thereby providing the composed information to the apparatus for providing the location based-broadcasting service. In this instance, the location based service information providing server may transmit the service information including the location information and the program information via the broadcasting network, or separately transmit the service information via the communications network.

The location based service module 330 may provide program information depending on location information of the user to the user using the service information received via either the broadcasting network receiving module or the communications network receiving module. In this instance, the service information may be included in either the broadcasting signal or the data signal. Also, the service information may include at least one of the location information and the program information.

Specifically, the location based service module 330 may process the service information received from either the broadcasting network receiving module 310 or the communications network receiving module 320, and additionally provide program information for each location other than a program guide provided to the user by the existing broadcasting system.

Also, as illustrated in FIG. 3, the location based service module 330 may include a location information database 331 and a service providing module 332.

The information database 331 may interconnect the location information and the program information using the service information received from either the broadcasting network receiving module or the communications network receiving module, and maintain the interconnected information.

In this instance, the location information of the location information database may include at least one of a location identifier of a specific region classified according to a predetermined criterion within the broadcasting coverage, a name of the specific region, coverage information composing the specific region, and link information concerning a program associated with the location information. Also, the coverage information may include longitude information, latitude information, and altitude information each composing a location midpoint of the specific region, and also includes longitude radius information, latitude radius information, altitude radius information each composing the specific region with respect to the midpoint.

For example, the location information may include a ‘location_id’ field of the location identifier of the specific region, ‘location_name’ field of the name of the specific region, and ‘coordinate_descriptor’ of a field describing the coverage information composing the specific region. In this instance, the coverage information may include a longitude, a latitude, and an altitude each composing the location midpoint within the broadcasting coverage, and also include the longitude radius information, the latitude radius information, and the altitude radius information with respect to the midpoint. Also, the location information may include ‘link_id’ of the link identifier for connection with program information corresponding to services and events related with the corresponding location.

The service providing module 332 may extract, from the location information database, the program information related with the location information required by the user, and provide the extracted information to the user. Specifically, the service providing module 332 may passively provide program information concerning a specific region when the user wishes to obtain the program information concerning the specific region.

For example, the service providing module 332 may interconnect program information provided via a specific broadcasting network or other broadcasting network with a specific location using each field and related information of the location information database, thereby providing the interconnected information acting as a guide of the location based broadcasting service. Also, the service providing module 332 may add a location based table or the related information in the conventional Electronic Program Guide (EPG) providing scheme, and display services for each location, that is, program information to thereby provide guide services for each location to the user.

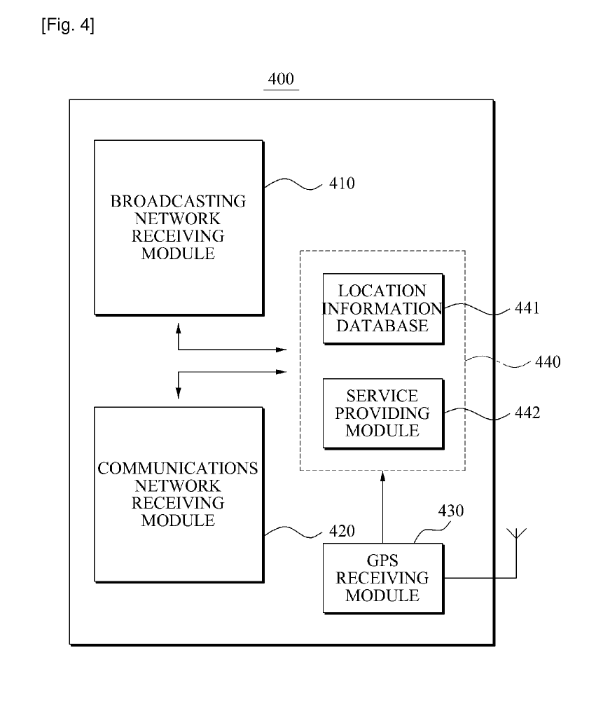

FIG. 4 is a block diagram illustrating an apparatus 400 for providing a location based broadcasting service according to an exemplary embodiment of the present invention.

As illustrated in FIG. 4, the apparatus 400 for providing the location based broadcasting service may include a broadcasting network receiving module 410, a communications network receiving module 420, a GPS receiving module 430, and a location based service module 440.

The broadcasting network receiving module 410 may receive a broadcasting signal transmitted via a broadcasting network.

Specifically, the broadcasting network receiving module 410 may receive, from a location based service information providing server via the broadcasting network, service information included in the broadcasting signal. In this instance, the broadcasting network receiving module 410 may receive, from the location based service information providing server via a broadcasting transmitting system managing the broadcasting signal, service information included in the broadcasting signal.

The communications network receiving module 420 may receive a data signal transmitted via a communications network.

Specifically, the communications network receiving module 420 may receive, from the location based service information providing server via the communications network, the service information included in the data signal.

The above-described broadcasting network receiving module 410 and communications network receiving module 420 are the same as the broadcasting network receiving module 310 and communications network receiving module 320 illustrated in FIG. 3, and thus repeated descriptions thereof will be omitted.

The GPS receiving module 430 may determine location information of the user. Specifically, the GPS receiving module 430 may determine the location information of the user using the apparatus 400 for providing the location based broadcasting service according to a predetermined location tracking process.

For example, the GPS receiving module 430 may determine the location of the user using a satellite navigation system. Also, the GPS receiving module 430 may determine the location of the user using analysis of an earth magnetic field. However, the determination of the location information obtained by using either the satellite navigation system or the analysis of the earth magnetic field is merely an exemplary embodiment of the invention, and thus various determinations of the location information can be made without departing from the sprit of the invention.

The location based service module 440 may provide, to the user, the program information depending on the location information of the user received from the GPS receiving module 430 using service information received from either the broadcasting network receiving module or the communications network receiving module. In this instance, the service information may be included in either the broadcasting signal or the data signal. Also, the service information may include at least one of the location information and the program information.

Specifically, the location based service module 440 may process the service information received from either the broadcasting network receiving module 410 or the communications network receiving module 420, and additionally provide program information for each location other than a program guide provided to the user by the existing broadcasting system. In this instance, the location based service module 440 may receive the location information of the user from the GPS receiving module 430, and thus checking a current location of the apparatus 400 for providing the location based broadcasting service, and generating an event associated with the current location. In this instance, the event may be predetermined screen information exposed to the user using the program information.

Also, as illustrated in FIG. 4, the location based service module 440 may include a location information database 441 and a service providing module 442.

The location information database 441 may interconnect the detected location information and program information using the service information received from either the broadcasting network receiving module or the communications network receiving module, and maintain the interconnected information.

The location information may include at least one of a location identifier of a specific region classified according to a predetermined criterion within the broadcasting coverage, a name of the specific region, coverage information composing the specific region, and link information concerning a program associated with the location information.

Also, the coverage information may include longitude information, latitude information, and altitude information each composing a location midpoint of the specific region, and also includes longitude radius information, latitude radius information, altitude radius information each composing the specific region with respect to the midpoint. Also, the program information may be broadcasting related information generated according to the location information.

Also, the above-described location information database 441 is the same as the location information database 331 illustrated in FIG. 3, and thus repeated descriptions thereof will be herein omitted.

The service providing module 442 may extract, from the location information database, the program information associated with the location information received from the GPS receiving module, and provide the extracted information to the user.

For example, the service providing module 332 may interconnect program information provided via a specific broadcasting network or other broadcasting network with a specific location using each field and related information of the location information database, thereby providing the interconnected information acting as a guide of the location based broadcasting service. Also, the service providing module 332 may add a location based table or the related information in the conventional EPG providing scheme, and display services for each location, that is, program information to thereby provide guide services for each location to the user.

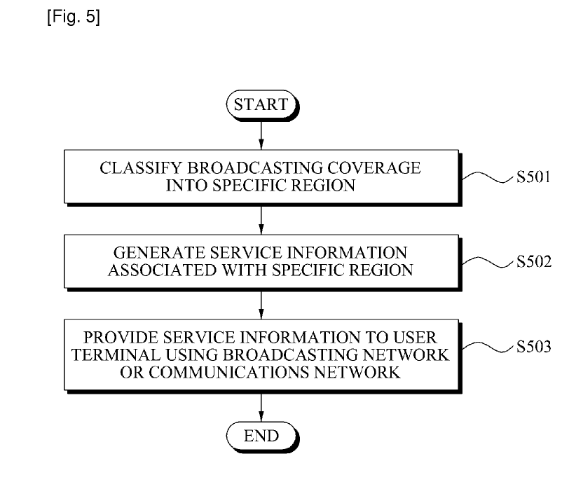

FIG. 5 is an operation flowchart illustrating a method for providing a location based broadcasting service according to an exemplary embodiment of the invention.

As illustrated in FIG. 5, the method for providing the location based broadcasting service may include operations S501 to S503. Also, the method for providing the location based broadcasting service may be performed by the apparatus for providing the location based broadcasting service.

In operation S501, the apparatus for providing the location based broadcasting service may classify a broadcasting coverage into at least one specific region.

The classification of the broadcasting coverage is similar to or same as that in FIG. 2, and thus repeated descriptions thereof will be herein omitted.

In operation S502, the apparatus for providing the location based broadcasting service may generate service information including location information of the specific region and program information associated with the location information.

In this instance, the location information may include at least one of a location identifier of the specific region classified according to a predetermined criterion within the broadcasting coverage, a name of the specific region, coverage information composing the specific region, and link information concerning a program associated with the location information.

Also, the coverage information may include longitude information, latitude information, and altitude information each composing a location midpoint of the specific region, and also includes longitude radius information, latitude radius information, altitude radius information each composing the specific region with respect to the midpoint. Also, the program information may be broadcasting related information generated according to the location information.

The above-described location information and the program information are the same as the location information and the program information included in the location information database 331 of FIG. 3, and thus repeated descriptions thereof will be herein omitted.

In operation S503, the apparatus for providing the location based broadcasting service may provide the service information using either the broadcasting network or the communications network to a user terminal.

Specifically, the apparatus for providing the location based broadcasting service may provide, to the user, the service information together with a part or the entire broadcasting signal provided to the user terminal via the broadcasting network. In this instance, the service information may be provided to the user terminal via the broadcasting transmitting system for providing the broadcasting signal to the user terminal. Also, the broadcasting transmitting system is the same as that in FIG. 3, and thus repeated description thereof will be herein omitted.

Also, the apparatus for providing the location based broadcasting service may provide, to the user, the service information together with a part or the entire broadcasting signal provided to the user terminal via the broadcasting network.

Specifically, the apparatus for providing the location based broadcasting service may classify the broadcasting coverage into specific regions and compose location information about the corresponding region and program information associated with the corresponding location, thereby providing the composed information to the user terminal. In this instance, the apparatus for providing the location based broadcasting service may transmit the service information including the location information and the program information to the user terminal via the broadcasting network, or separately transmit the service information to the user terminal via the communications network.

As described above, according to the present invention, there are provided an apparatus and method for providing a location based broadcasting service which may classify and generate service information related with location information of a user terminal, thereby optimum program information or broadcasting event information according to a mobile environment of the user terminal.

According to the present invention, there are provided an apparatus and method for providing a location based broadcasting service which may automatically or manually provide program information related with location information of a user terminal using a Global Positioning System (GPS) receiving module.

According to the present invention, there are provided an apparatus and method for providing a location based broadcasting service which may provide, to a user terminal, essential program information, event information, and location information related with any specific location, or location related effective information.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for providing a location based-broadcasting service, the apparatus comprising:
a broadcasting network receiving module to receive a broadcasting signal transmitted via a broadcasting network;
a communications network receiving module to receive a data signal transmitted via a communications network; and
a location based service module to provide, to a user, program information according to location information of the user using service information received from either the broadcasting network receiving module or a communications network receiving module, the service information being included in either the broadcasting signal or the data signal,
wherein the service information includes at least one of the location information and the program information.

2. (canceled)

3. The apparatus of claim 1, wherein the location based service module includes:
a location information database to interconnect the location information and the program information and maintain the interconnected information, the location information and the program information each being detected using the service information received from either the broadcasting network receiving module or the communications network receiving module; and
a service proving module to extract, from the location information database, program information associated with location information required by the user, and provide the extracted program information to the user.

4. The apparatus of claim 3, wherein the location information of the location information database includes at least one of a location identifier of a specific region classified according to a predetermined criterion within a broadcasting coverage, a name of the specific region, coverage information composing the specific region, and link information concerning a program associated with the location information,
wherein the program information is broadcasting related information generated according to the location information.

5. The apparatus of claim 4, wherein the coverage information includes longitude information, latitude information, and altitude information each composing a location midpoint of the specific region, and also includes longitude radius information, latitude radius information, altitude radius information each composing the specific region with respect to the midpoint.

6. (canceled)

7. The apparatus of claim 1, wherein the broadcasting network receiving module receives, from a location based-service information providing server via the broadcasting network, the service information included in the broadcasting signal,
wherein the communications network receiving module receives, from the location based-service information providing server via the communications network, the service information included in the data signal.

8. The apparatus of claim 7, wherein the broadcasting network receiving module receives, from the location based-service information providing server via a broadcasting transmitting system managing the broadcasting signal, the service information included in the broadcasting signal.

9. (canceled)

10. An apparatus for providing a location based broadcasting service, the apparatus comprising:
a broadcasting network receiving module to receive a broadcasting signal transmitted via a broadcasting network:
a communications network receiving module to receive a data signal transmitted via a communications network;
a Global Positioning System (GPS) receiving module to determine location information of a user; and
a location based service module to provide, to the user, program information according to the location information of the user received from the GPS receiving module using service information received from either the broadcasting network receiving module or the communications network receiving module, the service information being included in either the broadcasting signal or the data signal.

11. The apparatus of claim 10, wherein the service information includes at least one of the location information and the program information, and the location based service module includes:
a location information database to interconnect the location information and the program information and maintain the interconnected information, the location information and the program information each being detected using the service information received from either the broadcasting network receiving module or the communications network receiving module; and
a service providing module to extract, from the location information database, program information associated with location information received from the GPS receiving module, and provide the extracted program information to the user,
wherein the program information is broadcasting related information generated according to the location information.

12. The apparatus of claim 11, wherein the location information of the location information database includes at least one of a location identifier of a specific region classified within a broadcasting coverage, a name of the specific region, coverage information composing the specific region, and link information concerning a program associated with the location information.

13. The apparatus of claim 12, wherein the coverage information includes longitude information, latitude information, and altitude information, each composing a location midpoint of the specific region, and also includes longitude radius information, latitude radius information, and altitude radius information, each composing the specific region with respect to the midpoint.

14. (canceled)

15. The apparatus of claim 10, wherein the broadcasting network receiving module receives, from a location based-service information providing server via the broadcasting network, the service information included in the broadcasting signal, or the communications network receiving module receives, from the location based-service information providing server via the communications network, the service information included in the data signal.

16. The apparatus of claim 15, wherein the broadcasting network receiving module receives, from the location based-service information providing server via a broadcasting transmitting system managing the broadcasting signal, the service information included in the broadcasting signal.

17. A method for providing a location based broadcasting service, the method comprising:
classifying a broadcasting coverage into at least one specific region;
generating service information including location information of the specific region and program information associated with the location information; and
providing the service information to a user terminal using either a broadcasting network or a communications network.

18. The method of claim l7, wherein the location information includes at least one of a location identifier of the specific region classified within the broadcasting coverage, a name of the specific region, coverage information composing the specific region, and a link elucidator concerning a program associated with the location information.

19. The method of claim 18, wherein the coverage information includes longitude information, latitude information, and altitude information each composing a location midpoint of the specific region, and also includes longitude radius information, latitude radius information, and altitude radius information, each composing the specific region with respect to the midpoint.

20. The method of claim 17, wherein the program information is broadcasting related information generated according to the location information.

21. The method of claim 17, wherein the providing of the service information using the broadcasting network provides, to the user, the service information together with a part or the entire broadcasting signal provided to the user terminal via the broadcasting network.

22. The method of claim 21, wherein the service information is provided to the user terminal via a broadcasting transmitting system for providing the broadcasting signal to the user terminal.

23. The method of claim 17, wherein the providing of the service information using the communications network provides, to the user, the service information together with a part or the entire broadcasting signal provided to the user terminal via the broadcasting network.
